(19) United States
(12) Patent Application Publication
(10) Pub. No.: US 2006/0088292 A1
(43) Pub. Date: Apr. 27, 2006

(54) Method for tagging and displaying songs in a digital audio player

(76) Inventors: Newton Galileo Guillen, Carmel, IN (US); Lisa Renee Johnson, Indianapolis, IN (US); Botao Lin, Stafford, TX (US); Kam Keung Fung, Hongkong (CA)

Correspondence Address: THOMSON LICENSING INC., PATENT OPERATIONS, PO BOX 5312, PRINCETON, NJ, 08543-5312, US

(21) Appl. No.: 10/538,156

(22) PCT Filed: Dec. 16, 2003
(86) PCT No.: PCT/US03/39886

§ 371 Date: Jun. 9, 2005

Related U.S. Application Data
(60) Provisional application No. 60/434,710, filed on Dec. 17, 2002.
(60) Provisional application No. 60/434,711, filed on Dec. 17, 2002.

(51) Int. Cl. H04N 5/781

(52) U.S. Cl. 386/96; 386/125

(57) ABSTRACT

A method for determining and displaying the status of a user selectable parameter associated with a song stored in a digital audio player. The method allows a handheld player that has limited computing power to easily determine the status of the user selectable features and display the status. The method includes generating a preference table that is stored in a mass storage device associated with the player. The preference table includes an entry for each selected song stored on the mass storage device, wherein each entry includes a unique identifier and data fields having data indicative of the status of the user selectable parameters. The unique identifiers correspond to the unique identifiers stored in a playlist file. During navigation of the playlist, the unique identifier is compared with the preference table to identify the corresponding entry and the applicable data field is read to determine the status of the user selectable parameters and to display the status information.

### CROSS-REFERENCE TO RELATED APPLICATIONS

This application claims the benefit of U.S. Provisional Applications having Ser. No. 60/434,711, filed Dec. 17, 2002, entitled “Method for Tagging and Displaying Songs in a Digital Audio Player” and Ser. No. 60/434,710, filed Dec. 17, 2002, entitled “Method for Using User Like/Dislike Input to Determine the Probabilities of a Song Being Played During Shuffle Mode.”

### BACKGROUND OF THE INVENTION

1. Field of the Invention

The present invention relates to an apparatus and a method for processing digitally encoded audio data, and in particular, to a method, an apparatus, and a data structure related to tracks stored in a mass storage device associated with a digital audio player.

2. Description of the Related Art

The use of portable audio data players capable of playing digitally encoded audio data has become commonplace. In particular, relatively small handheld devices that can process digitally encoded audio data stored on solid state memory devices have become popular. Additionally, as demand has increased for higher data storage capacity in portable audio data players, another generation of players that include miniaturized high capacity hard drives has been developed and is gaining popularity.

In an audio data player, the digital audio data generally is loaded into a data storage device by first downloading the data to a PC from an audio CD, the Internet, or another digital audio device. The data is then usually compressed according to a selected encoding format and loaded into the data storage device associated with the audio data player.

The audio data is decompressed/decoded by the audio data player during playback according to the selected encoding format. A variety of encoding formats for compressing and decompressing audio data is available. As used hereinafter, the term encoding format refers to any encoding/decoding scheme that specifies the syntax and semantics of a compressed bitstream and how the bitstream must be decompressed for reproduction. Such encoding formats include, but are not limited to, MP3 and MP3 Pro.

For MP3 encoded audio data files, the data file is prepended or appended with a special set of frames called an ID3 tag. The ID3 tag contains descriptive text and other data relevant to the audio data file. For example, the tag may include title, artist, album, year, comments, and genre. ID3 tag information is useful for searching, sorting, and selecting specific audio data files based on the information contained in the ID3 tag. Because ID3 tag information is often stored as textual characters, the information can be displayed on the display screen of an audio data player.

Most PC-based audio data file management programs allow the user to create and edit playlists that can then be downloaded to a portable audio data player and used for playing a select sequence of audio data files. One such form of playlist typically associated with MP3 audio data files is known as an M3U playlist. An M3U playlist consists simply of a text file containing a sequential list of paths or locations of data audio files included in the playlist. Thus, a playlist created on a PC and downloaded to an audio data player may be used to selectively play a sequence of audio data files that are contained in the data storage of the audio data player. However, the M3U file format includes only the file location or path information and a comment field. Thus, the M3U file format allows the player to playback a predetermined sequence of audio data files, but does not contain other audio data file information such as the information contained in an ID3 tag of an MP3 audio data file.

PC-based audio data file management programs also allow the user to sort available audio data files by their content, such as by ID3 fields for MP3 audio data files. PCs generally have the processing power to quickly extract the content description information from the audio data files and also have the necessary memory to store this information and display it in a timely manner to the user. However, such processing is generally not practical in non-PC-based audio data players, particularly portable or hand-held players, which have limited processing power and memory. This limitation is especially acute in audio data players having high-capacity data storage that is able to store several hundred or thousand audio data files. Therefore, browsing available audio data files in various sequences according to their ID3 information has not been available in non-PC-based audio data players. Also, a simple method for determining and displaying various user selectable parameters associated with a song has not been available in non-PC-based audio data players.

In some non-PC-based audio data players a user may “tag” certain songs to be place in a playlist. The term tagging refers to a process whereby the user selects a particular song displayed on a display device of the player, for example, by pressing a select key, and the selected song is placed in a list of songs that is stored. The playlist may be stored into a memory after the number of tagged songs reaches a certain number. In a non-PC-based audio data player having a relatively small display and a very large number of stored songs, the process of tagging songs, and remembering which songs were tagged for inclusion in the playlist may be difficult for the user. In this regard, there is a need for a digital audio data player that enables a user to easily tag various songs and provide a display to remember which songs have been tagged.

Also, audio data players generally provide various playback modes including a shuffle mode. In the shuffle mode, the player randomly generates a playback sequence from all the songs stored on the player, or a playlist stored on the player. In that regard, the user may have preferences for certain songs over others, and would prefer that certain songs are played back more frequently. In this regard, there is a need for a digital audio data player that enables a user to record whether a certain song is liked or disliked, and to provide a shuffle mode that generates a playback sequence that is responsive to the user indication of like or dislike.

### BRIEF SUMMARY OF THE INVENTION

The present invention addresses some of the above-noted limitations of audio data players, particularly handheld audio players, by providing a preference table that is read from a mass storage device of the player during a startup operation of the player and is stored in the mass storage device of the player during a shutdown operation of the player. The preference table includes a plurality of entries, each entry being associated with a song stored in the audio data player. Each entry includes a unique identification associated with the song and includes parameter data indicating whether the song has been selected for inclusion in a playlist, whether the song is liked and whether the song is disliked. The preference table may be used in conjunction with a playlist, or the list of songs stored on the player, to determine and display the status of various user selectable parameters associated with the songs on the list. For example, the preference table may be used to display whenever a particular song has already been selected for inclusion in a playlist. The preference table is updated during operation of the player whether the user makes any changes to the user selectable parameters. The use of a separate preference table allows the player to quickly sort through the list of songs by checking the unique identification rather than looking at the actual identification information, for example the ID3 tag information, associated with the stored song.

The audio data player generally includes a microcontroller coupled with a user interface, data storage, buffer memory, and an audio decoder. The user interface includes an LCD and a keyboard having various multi-way and multi-function switches. The audio data player also provides a universal serial bus (“USB”) port for connection to a PC or other USB-equipped device. By connecting the audio data player to a PC via the USB port, audio data files and audio playlists may be downloaded to the audio data player and stored into data storage. In one embodiment, the data storage comprises a 10 GB hard drive; however, other moving data storage media or solid state memory devices, such as flash memory cards, may also be used. In this embodiment, the user interface provides menu driven selection, sorting, and playback of audio data files. Additionally, during playback of an audio data file, the LCD displays ID3 tag information such as title, artist, album, and genre. The LCD screen may also display other information such as elapsed playback time, volume level, and preset DSP mode.

The disclosed embodiment of the audio data player is a portable handheld unit having a rechargeable battery, 5 volt DC input, headphones output port, and line out port. Therefore, the audio data player may be used for portable applications using headphones, or for fixed applications using AC power and headphones or another audio device.

Advantageously, the disclosed data structure supports and enhances user interface and navigation tasks in viewing and selecting audio data files stored on a high-volume data storage device. Additionally, the present invention allows non-PC-based audio data players with limited processing power and memory to provide a user interface and navigation features that allow players to display the state of the user selectable parameters associated with audio data files stored in a data storage device.

A further advantage of the present invention is that non-PC-based audio data players may determine and display the user selectable parameters associated with the songs in the playlist without having to read the data directly from each audio file.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of a portable audio data player using the method for determining and displaying the user selectable parameters according to the present invention;

FIG. 2 is a top view of a portable audio data player using the method for determining and displaying the user selectable parameters according to the present invention;

FIG. 3 is a back view of the portable audio data player of FIG. 2;

FIG. 4 is a right side view of the portable audio data player of FIG. 2;

FIG. 5A is a view of the main sort-by menu displayed on the audio data player of FIG. 2;

FIG. 5B is a view of the artist menu displayed on the audio data player of FIG. 2;

FIG. 5C is a view of the album menu displayed on the audio data player of FIG. 2; and

FIG. 5D is a view of the song or track menu displayed on the audio data player of FIG. 2.

Corresponding reference characters indicate corresponding parts throughout the several views. The exemplification set out herein illustrates one embodiment of the invention, in one form, and such exemplifications are not to be construed as limiting the scope of the invention in any manner.

### DETAILED DESCRIPTION OF THE INVENTION

The embodiment disclosed below is not intended to be exhaustive or limit the invention to the precise form disclosed in the following detailed description. Rather, the embodiment is chosen and described so that others skilled in the art may utilize its teachings.

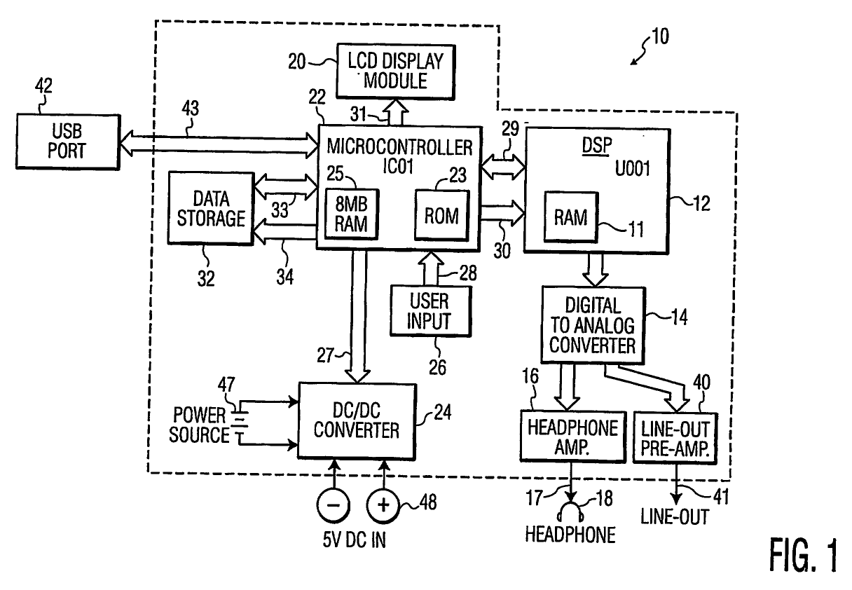

FIG. 1 shows a block diagram of portable audio data player 10 according to the present invention. The general arrangement and operation of the various elements are described hereinbelow. However, the details of the various elements of audio data player 10 are generally known to those skilled in the art and will not be discussed here. Audio data player 10 comprises DSP 12 that controls the various elements and the overall operation of audio data player 10, including transferring data from data storage 32, through buffer memory 25, and decoding compressed audio files. DSP 12 includes a suitable amount of memory 23 and 11, for storing various instruction sets and programs for controlling the operation of audio data player 10.

DSP 12 may be programmed to perform a variety of signal processing functions during playback of a selected audio data file. In this case, the functions that DSP 12 performs during playback include, but are not limited to, decoding audio data files, volume control, digital sound equalization, and sample conversion. In that regard, DSP 12 includes onboard memory 11, wherein the decoder files, audio data files, equalizer mode selection, and various other required data are loaded during playback.

The decoder files comprise programs that control the decoding operations of DSP 12 and the audio data files include data associated with the audio content. Both the audio data files and the decoder files are stored in data storage 32. The decoder file including the programs are transferred to DSP memory 11 from data storage 32.

Audio data and decoder programs stored in data storage 32 may be encrypted, requiring that decoding program files and audio data files be decrypted by DSP 12 using one or more decryption keys. The decryption keys may also be stored in data storage 32 and may be security linked to the particular storage device or some other coded component of audio data player 10 so that audio data files encrypted for use on a particular audio data player may only be decrypted and played by that particular audio data player.

As a selected audio data file is decoded, DSP 12 provides the decoded data stream to digital to analog converter 14. D/A converter 14 converts the digital output of DSP 12 into an analog signal and provides the analog signal to headphones amplifier 16 and lineout pre-amp 40. The analog signals are amplified and provided to lineout jack 41 and headphones jack 17, both disposed on housing 13 of audio player 10.

Audio player 10 is adapted to operate with data storage 32. In this embodiment, data storage 32 is a moving data storage device, specifically a hard drive, that can be used to store various data files, including encoded audio data files, decoder files for controlling the decoding operation of DSP 12, playlist files, and computer data files, such as, for example, word processing files, presentations, and spreadsheets. A large amount of data can be readily transferred between data storage 32 and DSP 12 through data bus 33. Buffer memory 25 may operate as a circular data buffer to prevent interruption of audio playback caused by a skip or other similar moving data storage device data transfer delays. Using the present invention, decoder files, playlists, and relatively large amounts of audio data may be stored on data storage 32.

In accordance with the present invention, audio data files are loaded into data storage 32 via USB port 42 from a PC, or other similar device, using music management software that encodes the audio data files in accordance with a selected encoding format, such as MP3, or MP3 Pro, and then stores the encoded data files. Such music management software is implemented using programming methods known in the art. The music management software transmits the audio data files and appropriate decoder files to audio data player 10 across data buses 43 and 33 and into data storage 32. The music management software also generates, and modifies as necessary, a system configuration file and a file attribute table to provide information regarding the various data files and decoder files stored in data storage 32. Using the configuration file and the file attributes table, audio data player 10 is able to display audio data files sorted by various groupings on display 21, determine the correct encoding format for each audio data file, and download the appropriate decoder file for each content file in response to a user selection.

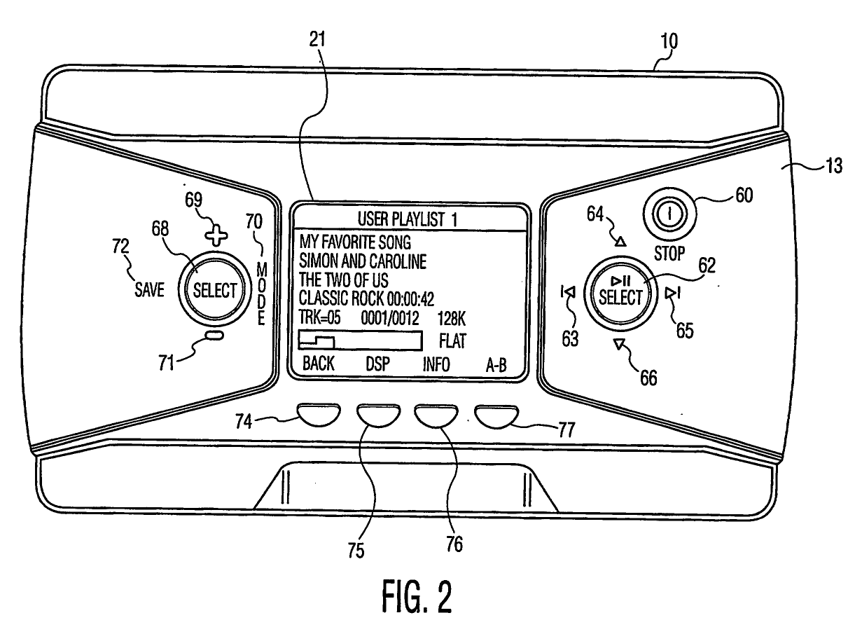

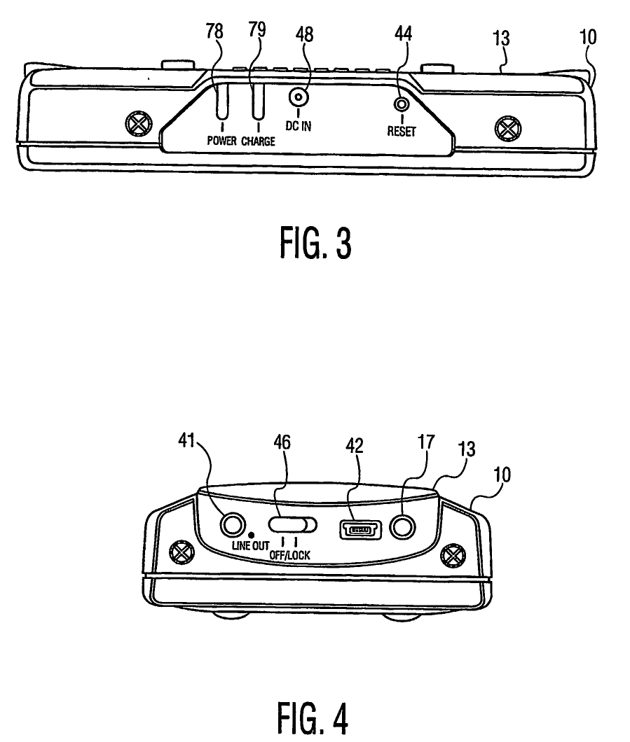

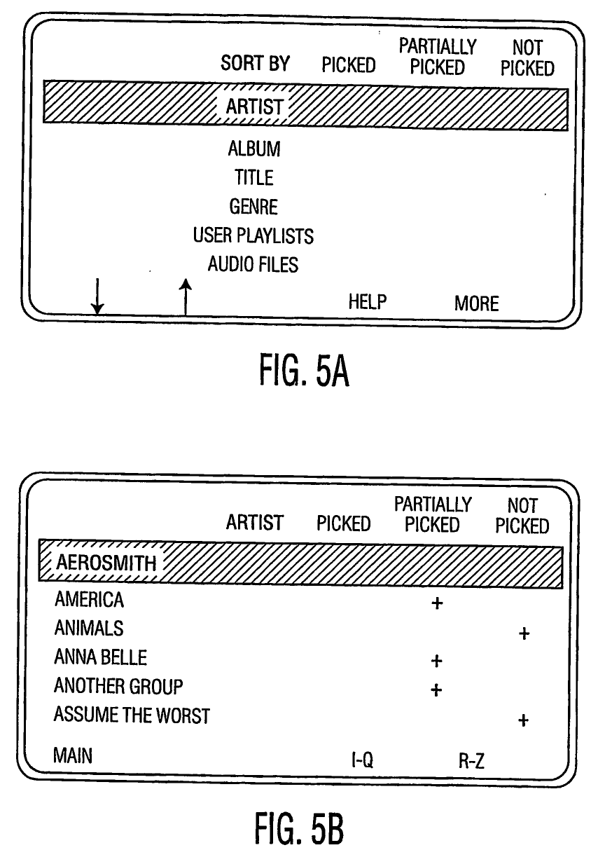

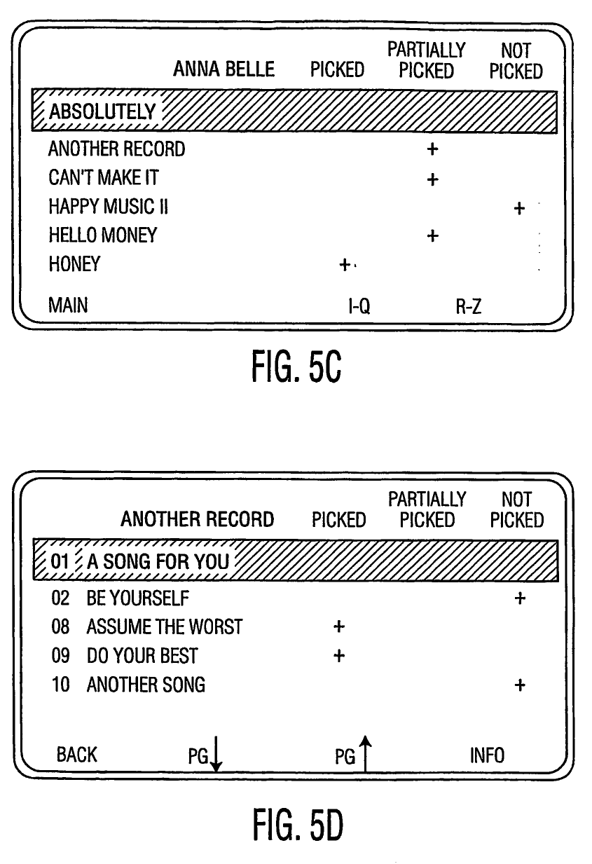

FIGS. 2-4 illustrate an exemplary embodiment of the displays, buttons, switches, indicators, and ports, which may be disposed on housing 13 of audio data player 10. Referring to FIG. 2, user input 26 comprises a plurality of buttons 44 (FIG. 3), 46 (FIG. 4), and 60-77 disposed on housing 13 of audio data player 10 for allowing a user to sort and select particular audio data files for playback, and to control playback settings. User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes display 21 disposed on housing 13. Display 21 displays the audio data files and playlists stored in data storage 32, the function of soft keys 74-77, and various status information associated with audio data player 10, such as the playback status shown in FIG. 2 and the top-level menu shown in FIG. 5.

Referring again to FIG. 2, STOP/POWER button 60 allows the user to stop playback and to turn audio data player 10 on and off. PLAY/PAUSE button 62 allows the user to start playback and to pause playback. Left arrow button 63 allows a user to move a highlight left when using the menu, and to skip back to the previous audio data file or scan backward in the present audio data file when playing music. The right arrow button 65 allows the user to move a highlight right when using the menu, skip forward to the next audio data file, and scan forward in the current audio data file when playing music. Up arrow button 64 allows the user to move the highlight up when using the menu. Down arrow button 66 allows the user to move the highlight down when using the menu.

Referring still to FIG. 2, SELECT button 68 allows the user to select a highlighted item. Volume up button 69 increases the playback volume level for headphones 18 and volume down button 71 decreases the volume level. MODE button 70 allows the user to select a particular playback mode, including NORMAL, REPEAT, REPEAT ONE, REPEAT ALL, SHUFFLE, and REPEAT ALL SHUFFLE. SAVE button 72 allows a user to create a new playlist or add audio data files to an existing playlist. Soft keys 74-77 select the menu item that appears just above each button at the bottom of display 21.

Referring to FIG. 3, POWER indicator 78 lights when audio data player 10 is on. CHARGE indicator 79 lights when the power source 47 is charging. In the exemplary embodiment, power source 47 is a rechargeable battery pack. DC IN jack 48 provides 5 volt DC from an AC adapter to power audio data player 10 and recharge power source 47. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINE OUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

When the user selects a particular audio data file for playback via user input, DSP 12 loads the appropriate decoder file associated with the selected audio data file from data storage 32 into DSP memory 11. Referring again to FIG. 1, DSP 12 then streams the selected audio data file along buses 33 and 29 into buffer memory 25 as a skip-protection buffer.

After streaming of the selected audio data file begins, DSP 12 decodes the audio data file using an associated decoder file. Various decoder files may be stored in data storage 32 to allow audio player 10 to be adapted to process the various encoding formats associated with the audio data files stored in data storage 32. In effect, portable audio player 10 can be software upgraded, as necessary, by the decoder files stored in data storage 32 when the user selects a particular audio data file stored in data storage 32.

After powering up, DSP 12 of audio data player 10 loads the system configuration file from data storage 32. DSP 12 identifies the various file formats that need to be supported for the data files stored in data storage 32. The configuration file also includes information that equates the file extension of the audio data files with particular decoder files stored in data storage 32. If the configuration file is valid, DSP 12 reads the file attribute table stored in data storage 32 and causes display 21 to display a menu-driven listing of the file/folders stored in data storage 32.

Referring to FIG. 5A, the main menu displayed on display 21 allows the user to navigate and display audio data files according to groupings or identifying characteristics, such as, for example, artist, album, title, genre, playlist, and all audio data files. The listing on the display maybe generated and sorted using a playlist for each respective category, using, for example, the data structure and method described in “EXTENSION OF M3U FILE FORMAT TO SUPPORT USER INTERFACE AND NAVIGATION TASKS IN AN DIGITAL AUDIO PLAYER,” having Ser. No. 60/318,721, filed on Sep. 10, 2001, which is incorporated herein. In the present invention the unique track identifier described below is included with the playlist entries. From the main menu, the user may operate user input 26, as described above, to navigate sorted lists and select a desired one of the displayed audio data files or playlists for playback.

In the present embodiment, the necessary decoder files are stored in data storage 32 along with the audio data files. As such, audio player 10 may be updated to play different encoding formats by software updating of the DSP via decoder files stored along with the audio data files in data storage 32. Thus, audio data player 10 is capable of playing back data files encoded using a variety of encoding formats, including encoding formats that become available in the future.

During playback display, shown in FIG. 2, displays various information about the audio data file and the audio data player settings. For example, display 21 in FIG. 2 shows the file name, artist name, album title, genre, current track being played out of total files being played, volume level indication, elapsed play time of audio data file, playback mode indication, bit rate, and selected DSP mode selection.

Table 1 below shows the format of the preference table according to the present invention. The preference table is a data structure used to facilitate the implementation of playlist creation and referencing features in the present audio data player and to implement such as generating a shuffle list based on user indication of like and dislike.

The Preference Table format consists of a data structure that lists a unique identification for each track, the categories to which that track belongs, and a reference to one of the system playlist files where to get the complete path of the track. This data structure also contains a header with information such as the number of entries in the table, and a 32-bit number that gets incremented every time the contents of the table are changed. The fields of the preference table are described below.

TABLE 1

| Field Name | Number of Bits |
|---|---|
| preferenceTableVersion | 16 |
| preferenceTableUpdateCount | 32 |
| numberOfEntriesInTable | 32 |
| for(i=0; i < numberOfEntriesInTable; i++) | |
| { | |
| trackUniqueID (four 32-bit unsigned values) | 128 |
| reserved1 | 5 |
| likeFlag | 1 |
| dislikeFlag | 1 |
| pickFlag | 1 |
| reserved2 | 5 |
| sysPlaylistFileSource | 3 |
| sysPlaylistFileOffset | 32 |
| } | |

preferenceTableVersion

This field indicates the current revision of the preference table format. Any changes in the preference table format that could potentially affect the software that reads this table increases this number. The software that reads the preference table should check the version number to ensure it can support reading the specified version.

preferenceTableUpdateCount

This field starts with a value of zero and it is incremented by one every time a change is made to the preference table. When the maximum value (0×FFFFFFFF) is reached, the field starts from zero again. This field can be used to synchronize other files to the latest version of the preference table. One possible application is to include the preference flags in the system playlists, by remembering the value of the preferenceTableUpdateCount at the time the preference flags were updated in the playlist and comparing it to the current value in the preference table, the software can determine whether or not it needs to update the preference flags in the system file.

numberOfEntriesInTable

This field indicates the number of entries in the preference table. This number is updated every time an entry is added or removed from the table.

trackIndexInPlaylist

This field indicates the order of the current audio file information in the system playlist.

trackUniqueID

This field is a unique identifier that maps the full path of an entry to a hash-value. The proposed algorithm to be used in generating this number is the MD5 hash-key generation algorithm, which takes a character string of up to 256 characters and generates a unique 128-bit hash-key. In order to more efficiently use the contents of this field it should be stored as four unsigned 32-bit values and each of these values should be stored using big-endian format. The unique identifier is also listed with the corresponding entry in the playlist files to allow easy correlation of the entries.

reserved1

This field is reserved for future expansion and should be set to zero to ensure compatibility with future changes.

likeFlag

This is a binary field that indicates whether the user has selected the specified track to be in the like list. When this bit is set, it indicates the track associated with the trackUniqueID is part of the like playlist. When this bit is cleared, it indicates that the track associated with the trackUniqueID is not part of the like playlist. Note that the like and dislike playlists are mutually exclusive, therefore entries with both the likeFlag and dislikeFlag set are not allowed.

dislikeFlag

This is a binary field that indicates whether the user has selected the specified track to be in the dislike list. When this bit is set, it indicates the track associated with the trackUniqueID is part of the dislike playlist. When this bit is cleared, it indicates that the track associated with the trackUniqueID is not part of the dislike playlist. Note that the like and dislike playlists are mutually exclusive, therefore entries with both the likeFlag and dislikeFlag set are not allowed.

pickFlag

This is a binary field that indicates whether the user has selected the specified track to be in the pick list. When this bit is set, it indicates the track associated with the trackUniqueID is part of the pick playlist. When this bit is cleared, it indicates that the track associated with the trackUniqueID is not part of the pick playlist.

Reserved2

This field is reserved for future expansion and should be set to zero to ensure compatibility with future changes.

sysPlaylistFileSource

This field is one of two fields used to quickly find the full path of a track associated with a trackUniqueID. This field indicates a system playlist file where from where to read the path. The values in this field should be interpreted according to Table 2.

TABLE 2

| Value | System Playlist |
|---|---|
| 0 | Not Valid |
| 1 | Artist.m3u |
| 2 | Album.m3u |
| 3 | Genre.m3u |
| 4 | Title.m3u |
| 5 | Year.m3u |

sysPlaylistFileOffset

This field indicates a byte offset from the beginning of a specified system playlist from where to read the entry whose path corresponds to the trackUniqueID.

Power Up and Initialization

During the player initialization after power-up, the player reads the preference table from the disk and loads the contents of the entire table into memory. In the event that a preference table file is not found on the disk, the player creates a new preference table. The initial value of a new preference table consists of an empty table, with the proper version number specified and a count of zero entries.

Navigation

The preference table is used during the navigation process to determine whether a particular entry has been “picked” by the user. There are three possible states that an entry can have with regards to pick, these states are “picked”, “not picked”, and “partially picked”. Note that the “partially picked” state only applies to entries that represent more than one song (i.e. an album entry where not all songs are “picked”).
1. The player displays the entries for the desired navigation mode (i.e. If user selects artist, the player displays the first six artists from the profiler playlist).
2. The player reads the trackUniqueID from the profiler playlist and compare it with all the entries in the preference table to find the corresponding preference table entry and to determine if the pickFlag is set. In the case that the entry corresponds to a specific song, the entry indicates whether the song is picked, or not, and the indication is displayed on the player. In the case that an entry could represent more than one song (i.e. artist, album, genre, and year), the player checks each song represented by the entry. If all songs have the pickFlag set, then the entry is considered to be “picked”, if not all songs have the pickFlag set, then the entry is considered “partially picked”. Finally is none of the songs have the pickFlag set, the entry is considered “not picked”.
3. For each entry, the player then displays the appropriate icon for “picked” and “partially picked” entries, as shown, for example on FIGS. 5B and 5C.
4. As the user navigates (either up or down), the new entries should be processed according to steps 2 and 3 above. There is no need to update the existing entries in the current screen.
   Playback

During playback, the user has the ability to place songs in a “like” or “dislike” list. When a song in the “like” or “dislike” list is played, the software should display the appropriate icon indicating the state of the song. The status of the “like” or “dislike” can be determined by looking up the entry in the preference table in a manner similar to the “picked” status. The “like” and “dislike” states are also used to affect the probability that a song would be played when the unit is operating under shuffle mode.

For normal playback the player follows the steps described below:
1. The player reads (from profiler playlists) or calculates (from full path) the trackUniqueID for each file as it is read from the disk and it keeps this information along with other file relevant information.
2. When starting to play a file, the player compares the read or calculated trackUniqueID with the contents of the preference table. If the entry has its likeFlag or dislikeFlag set, then the player displays the appropriate icons.

For shuffle playback, the player follows the steps described below:
1. Prior to starting the shuffling algorithm, the player determines the total number of entries to shuffle.
2. The player also determines the number of “like” entries within the group of entries to shuffle and adds this to the total number of songs to shuffle. (i.e. if there are a total of 10 songs to shuffle, and 3 of those songs have the likeFlag field set in the preference table, then the total number of songs to shuffle is 13).
3. The player applies a 50% possibility to “dislike” entries, 100% for normal entries, and 200% for “like” entries. The 200% for “like” entries is accomplished automatically by increasing the number of shuffling entries. When the shuffling algorithm produces a number larger than the total number of actual entry (i.e. number 11 in the example above), the player actually selects the “like” entry from the beginning of the entries that is indexed by the (shuffling index—number of entries). The 50% for “dislike” songs is accomplished by alternating whether an entry with the dislikeFlag set is played or not. The first time a “dislike” entry is encountered, it is played, the second time any other “dislike” song is encountered, the player simply ignores it and gets the next entry from the standard shuffling algorithm.
   Preference Table Updates

All entries are added to the end of the table. Adding an entry to the preference table requires the following steps:
1. Add new entry to end of table in location numberOfEntriesInTable+1
2. Increment the numberOfEntriesInTable field by one
3. Increment the preferenceTableUpdateCount by one, if reached 0×FFFFFFFF, start this field at zero.
   An entry should be removed from the preference table when none of its preference flags are set (i.e. likeFlag=0, dislikeFlag=0, and pickFlag=0). Removing an entry requires the following steps:
1. Shift all entries following the entry to be deleted up by one position. Decrement the numberOfEntriesinTable field by one
2. Increment the preferenceTableUpdateCount by one, if reached 0×FFFFFFFF, start this field at zero
   Power-Down and Writing Preference Table to Disk
   When powering down, the player copies the entire contents of the preference table to disk. The format of the preference table file is identical to the preference table in memory and it should be written as a binary file that has the same contents of the preference table in memory.

In the exemplary embodiment, suitable DSP 12 include, but are not limited to, TMS320DA250 manufactured by Texas Instruments Inc., of Dallas, Tex. Associated with DSP 12 is memory 23, in this case, 48 KB of ROM, and buffer memory 25 comprising 8 MB of RAM, providing 7 minutes of buffered play time at 128 kbps and 14 minutes of buffered play time at 64 kbps. DSP 12 also includes associated memory 11, in this case 64 KB of RAM. Suitable hard drives for data storage 32 include, but are not limited to, Microdrive™ manufactured by IBM Corporation of Armonk, N.Y. A 10 GB hard drive, for example, provides approximately 150 hours of audio at MP3 bit-rate of 128 kbps, or 300 hours at a bit-rate of 64 kbps.

It will be apparent to those skilled in the art that although the present invention has been described in terms of an exemplary embodiment, modifications and changes may be made to the disclosed embodiment without departing from the essence of the invention. For example, although the present invention has been described with reference to data storage 32 that is fixedly disposed within audio player 10, the present invention may be implemented using flash memory, another fixed storage device, optical device, or a memory card that is adapted to be removably coupled to audio player 10, wherein the decoder program and audio data files are loaded onto the memory card by the music management software. Also, DSP12 and microcontroller 22 may be embodied within a single IC. Also, other user selectable parameters may also be included in the preference table for easy look up and display. Also, it is herein recognized that the present feature of loading the appropriate decoder programs and the audio data files may be implemented in the music management software using any one of a number of conventionally known programming methods, or combination of programming methods. Also, although the above is described in reference to an audio data player, the present invention may be extended to any portable data processing device, for example, video display devices, wherein the data may be encoded using one of a plurality of data encoding formats. Therefore, it is to be understood that the present invention is intended to cover all modifications as defined in the appended claims.

1. A method for determining and displaying the status of a user selectable parameter associated with a song stored in a digital audio player, comprising the steps of:
reading a preference table from a mass storage device associated with the digital audio player during a startup operation of the digital audio player, the preference table including an entry for each selected song stored in the mass storage device, each entry including a unique identifier associated with the selected song and parameter data indicative of the status of the user selectable parameter;
reading a playlist selected by the user;
displaying one or more entries included in the selected playlist on a display device associated with the multi-track audio player;
determining one or more unique identifiers associated with each entry included in the selected playlist;
comparing the determined unique identifiers with the unique identifiers included in the preference table to determine states of the selectable parameter associated with the entries in the selected playlist;
displaying the determined states of the selectable parameter with associated selected playlist entries on the display device.

2. The method according to claim 1, wherein the parameter data represents the status of at least 3 user selectable parameters, including whether the entry is tagged to be included in a playlist, whether the song is liked, and whether the song is disliked.

3. The method according to claim 2, further comprising the step of updating the preference table each time the user indicates whether a selected song is to be tagged, indicated to be liked, or indicated to be disliked.

4. The method according to claim 3, further comprising the step of storing the updated preference table in the mass storage device during a shutdown operation of the digital audio player.

5. The method according to claim 1, wherein each preference table entry includes playlist identification data that includes path information for locating a selected song on the mass storage device.

6. The method according to claim 1, wherein each unique identifier included in the preference table is generated using a hash function.

7. The method according to claim 1, further comprising the step of generating a playlist sequence using parameter data indicating whether a song is liked or whether a song is disliked, in response to user selection of a shuffle playmode.

8. A portable hand-held digital audio player, comprising:
a mass storage device;
user input device for allowing a user to select a playlist for display and select a state of a user selectable parameter associated with a song stored on the mass storage device;
a display device; and
a controller coupled to the mass storage device, the user input device, and the display device, the controller generating a preference table in response to user selection of the state of the user selectable parameter, storing the preference table to the mass storage device during a shut down operation of the digital audio player, and reading the preference table from the mass storage device during a startup operation of the digital audio player, wherein the preference table includes an entry for each selected song stored in the mass storage device, each entry including a unique identifier associated with the selected song and parameter data indicate of the status of the user selectable parameter,
the controller determining one or more unique identifiers associated entries in a playlist in response to user selection of the playlist, comparing the determining one or more unique identifiers with the unique identifiers in the preference table, determining the status of the selectable parameters in response to the comparison, and causing the display device to display one or more of the entries in the playlist with the status of the user selectable parameter associated with the entries.

9. The digital audio player according to claim 8, wherein the parameter data represents the status of at least 3 user selectable parameters, including whether the entry is tagged to be included in a playlist, whether the song is liked, and whether the song is disliked.

10. The digital audio player according to claim 9, wherein the controller updates the preference table each time the user indicates whether a selected song is to be tagged, indicated to be liked, or indicated to be disliked.

11. The digital audio player according to claim 10, wherein the controller stores the updated preference table in the mass storage device during a shutdown operation of the digital audio player.

12. The digital audio player according to claim 8, wherein each preference table entry includes playlist identification data that includes path information for locating a selected song on the mass storage device.

13. The digital audio player according to claim 8, wherein each unique identifier included in the preference table is generated using a hash function.

14. The digital audio player according to claim 8, wherein the controller generates a playlist sequence using parameter data indicating whether a song is liked or whether a song is disliked, in response to user selection of a shuffle playmode.
